(19) United States
(12) Patent Application Publication
(10) Pub. No.: US 2025/0121309 A1
(43) Pub. Date: Apr. 17, 2025

(54) FILTER AND FILTER ARRANGEMENT

(71) Applicant: Carl Freudenberg KG, Weinheim (DE)

(72) Inventors: Güngör BASTAN, Dreieich (DE); Maria BICKEL, Heddesheim (DE); Andreas BREUER, Birkenau (DE)

(21) Appl. No.: 18/912,631

(22) Filed: Oct. 11, 2024

(30) Foreign Application Priority Data
Oct. 16, 2023 (EP) 23 203 684.8

(51) Int. Cl. B01D 46/00; B01D 46/42; B01D 46/52; B60H 3/06

(52) U.S. Cl. CPC B01D 46/0002; B01D 46/4227; B01D 46/521; B60H 3/0608; B01D 2265/028; B01D 2271/02; B01D 2279/40

(57) ABSTRACT

A filter, including a pleated filter medium, an edge strip, and at least one retaining element. The edge strip is fastened on one side of the filter medium. The retaining element is assigned to the edge strip. The edge strip and the retaining element form a locking structure for fixing the filter in a filter housing.

### CROSS REFERENCE TO RELATED APPLICATIONS

This application claims benefit to European Patent Application No. EP 23 203 684.8, filed on Oct. 16, 2023, which is hereby incorporated by reference herein.

### FIELD

The invention relates to a filter and a filter arrangement.

### BACKGROUND

Filters for the filtration of fluids are generally known from the prior art. In particular, for the air filtration in vehicle cabins filters with pleated filter media are used. The filter media can have different layers, whereby the configuration and properties of the different layers determine the filtration efficiency of the filter and can be adapted to the respective intended use. It is mostly necessary to replace the filter after a predetermined period of use or if the filter medium is heavily soiled. For this purpose, filters are configured in such a way that they can be arranged interchangeably, for example in a filter housing.

DE 202 21 005 U1 shows an air filter with a filter element, as well as an air filter housing with an air filter opening that is lockable by means of a cover. The air filter comprises a seal for sealing between the air filter housing and the cover.

### SUMMARY

In an embodiment, the present disclosure provides a filter, comprising a pleated filter medium, an edge strip, and at least one retaining element. The edge strip is fastened on one side of the filter medium. The retaining element is assigned to the edge strip. The edge strip and the retaining element form a locking structure for fixing the filter in a filter housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view of a first embodiment of a filter;

FIG. 2 illustrates a further perspective view of the filter from FIG. 1;

FIG. 3 illustrates a detailed view of a retaining element of the filter from FIG. 1;

FIG. 4 illustrates a perspective view of a second embodiment of a filter;

FIG. 5 illustrates a perspective view of a first embodiment of a filter arrangement with the filter from FIG. 1; and

FIG. 6 illustrates a perspective view of a second embodiment of a filter arrangement with the filter from FIG. 2.

### DETAILED DESCRIPTION

In an embodiment, the present invention provides a filter which can be manufactured with improved handleability at low cost.

The filter according to the present disclosure comprises a pleated filter medium, an edge strip and at least one retaining element, wherein the edge strip is attached on one side of the filter medium, wherein the retaining element is assigned to the edge strip, wherein the edge strip and the retaining element form a locking structure for fixing the filter in a filter housing.

The retaining element can have a retaining structure, whereby the retaining structure can comprise a latching lug and a grip section. The latching lug can be configured as a latching flap so that the retaining element can be form-fittingly fixed in the filter housing by means of the latching flap. In this context, it is also provided that the latching lug is configured as a snap lock or retainer tab. This allows the filter to be detachably connected with the filter housing in order to improve the replaceability of the filter. The grip section allows the connection between the filter and the filter housing to be established and released again without tools, thus improving handleability during installation. Due to the configuration of the retaining element with latching section and grip section, the filter can be removed from the filter housing easily, quickly and without tools. In particular, it is not necessary to fix the filter in the filter housing using separate fastening means, such as covers and the like. For removal, the retaining elements can be gripped at the grip sections and bent in such a way that the latching means, e.g. the latching lugs or the retainer tabs, are released from the fastening sections of the filter housing so that the filter can be removed.

The retaining element can have a plate-shaped base body with two main sides, wherein the retaining structure is assigned to the first main side facing away from the edge strip. The retaining element can be arranged on the edge strip with the second main side facing the edge strip. Thereby the base body can be arranged on a narrow side of the edge strip. In particular, the base body can be arranged in a flush manner on one of the narrow sides of the edge strip. The edge strip can comprise an outer side facing away from the filter medium, whereby the retaining element is arranged on the outer side of the edge strip.

The filter medium can be zigzag-shaped and have elongated pleat walls and pleat backs. This increases the filter surface area of the filter medium. The filter medium can be arranged on the edge strip in such a way that the pleat walls and the pleat backs protrude essentially orthogonally from the edge strip.

The filter can comprise a seal for sealing the filter and the filter housing, whereby the seal is formed by the edge strip. The filter housing has a receiving space with a receiving opening, whereby the filter medium is inserted into the receiving space via the receiving opening. This results in a circumferential gap between the filter medium and the filter housing. The rims of the edge strip are configured in such a way that they come into contact with the filter housing in the installed state in order to cover the gap and thus improve the tightness. No separate seal is therefore required to seal the gap, which means that the number of components required can be reduced, in order to achieve a cost-effective manufacturing.

The edge strip can have a free end on at least each of its longitudinal sides that protrudes over the filter medium and forms the seal. The free end can fill the gap between the filter medium and the filter housing in such a way that the tightness is improved. The free end can have an elastic configuration so that the free end is deformed and compressed when the filter is inserted into the filter housing. This can compensate for unevenness in the gap, for example due to manufacturing tolerances, and further improve the tightness. The edge strip can also have a free end on each of its narrow sides that protrudes over the filter medium and forms the seal. Thus, a circumferential seal is formed. An improved sealing can also be achieved on the narrow sides via a retaining element arranged there, which also forms a seal.

The retaining element and/or the edge strip can be made of nonwoven fabric. Non-wovens are inexpensive to produce and have very good filter performances.

The material of the edge strip can have a basis weight of more than 140 g/m². The material of the edge strip can have a basis weight of less than 800 g/m².

The material of the retaining element can have a basis weight of more than 400 g/m². Preferably, the basis weight can be greater than 500 g/m². The material of the retaining element can have a basis weight of less than 800 g/m². Preferably, the basis weight can be less than 700 g/m². In a preferred embodiment, the material of the retaining element can have a basis weight of approximately 580 g/m².

The retaining element and the edge strip can be configured in one piece and in material uniformity. This configuration can further reduce the number of components and thus further improve handleability during installation and removal. Due to the material uniformity, the filter can be manufactured as a homogenous component, so that recyclability can also be improved. Furthermore, the manufacturing process can be simplified as no assembly steps are required for the connection between retaining element and edge strip.

The retaining element can be made of injection-moldable plastic and the edge strip can be made of non-woven fabric, whereby the retaining element is connected with the edge strip. Thereby the retaining element is configured as a molded part. Preferably, the retaining element is made of thermoplastic. The connection between the retaining element and the edge strip can be achieved by means of a material bond connection. Preferably, the connection is created by ultrasonic welding or gluing.

The filter can have at least one retaining element. The retaining element improves the handling of the filter and simplifies the installation in the filter housing and the removal of the filter from the filter housing. According to a first advantageous embodiment, two retaining elements are provided, which can each be arranged opposite each other on the edge strip on the two narrow sides of the edge strip. According to a further advantageous embodiment, two retaining elements are provided, which are arranged centrally on the two longitudinal sides. It is also provided that a single retaining element that protrudes beyond the two longitudinal sides is provided. The number and arrangement of the retaining elements is therefore variable and can be adapted, in particular, to the available installation space. Accordingly, retaining elements can also be arranged in other regions on the front side of the filter.

Preferably, the arrangement of the two retaining elements is limited to the immediate regions on the two narrow sides of the edge strip. The two retaining elements extend in the longitudinal direction of the edge strip preferably in each case over less than 20% of the length of the edge strip. As a result, the two retaining elements are only arranged in the end regions of the edge strip, so that no retaining element is arranged in a central region of the edge strip between the end areas. The retaining elements are therefore smaller in size, so that less material is required for manufacturing in order to enable a more cost-effective manufacturing.

The filter can be configured as a cabin air filter for mobile applications. One application, in particular, is in motor vehicles for filtering the vehicle cabin.

The filter arrangement according to the present disclosure comprises a filter housing and a filter according to the present disclosure, wherein the filter housing has a receiving space and a receiving opening, wherein the filter housing has a further locking structure which is assigned to the receiving opening and is configured to be complementary to the locking structure of the filter, so that the receiving opening is lockable by means of the locking structure of the filter.

The locking structure of the filter housing comprises at least one further retaining element, so that the retaining element of the filter can be fixed on the retaining element of the filter housing, in order to connect the filter to the filter housing. Preferably, the retaining element of the filter housing has a complementary shape to the retaining element of the filter, so that the retaining elements are form-fittingly connectable. It is also provided that the retaining elements are connectable in a force-fitting manner. The filter can thus be detachably connected to the filter housing, wherein the handleability is improved.

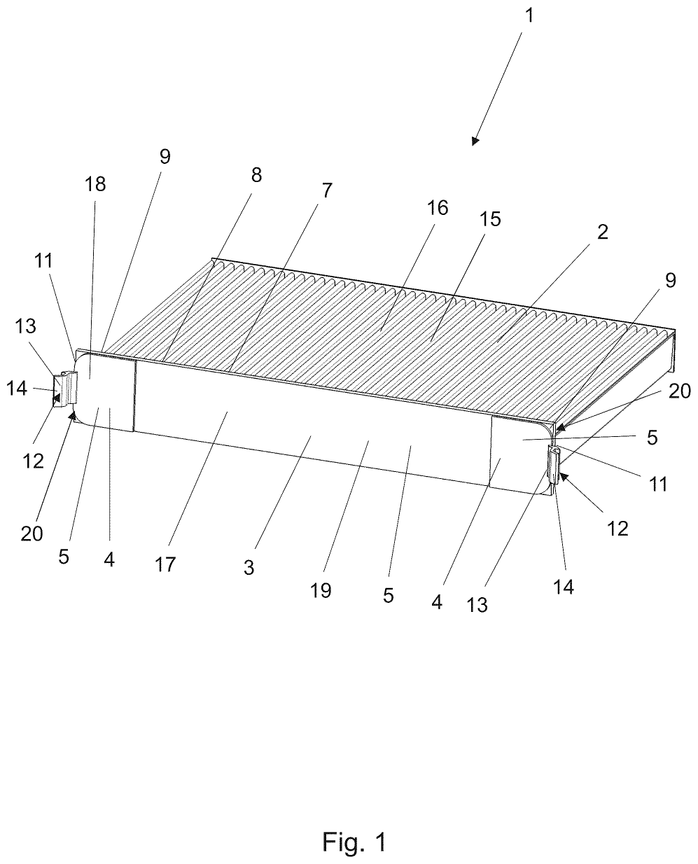

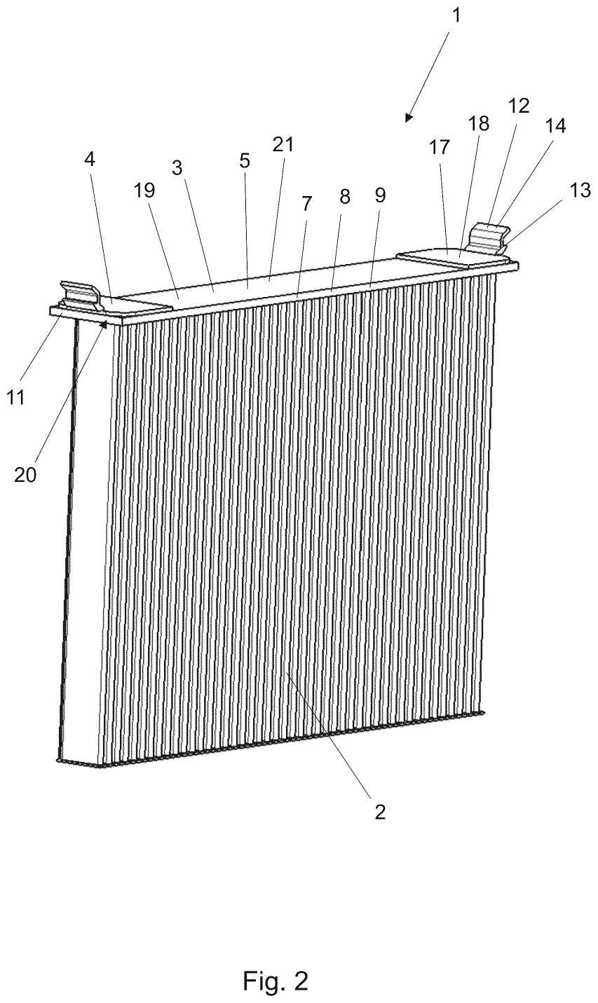

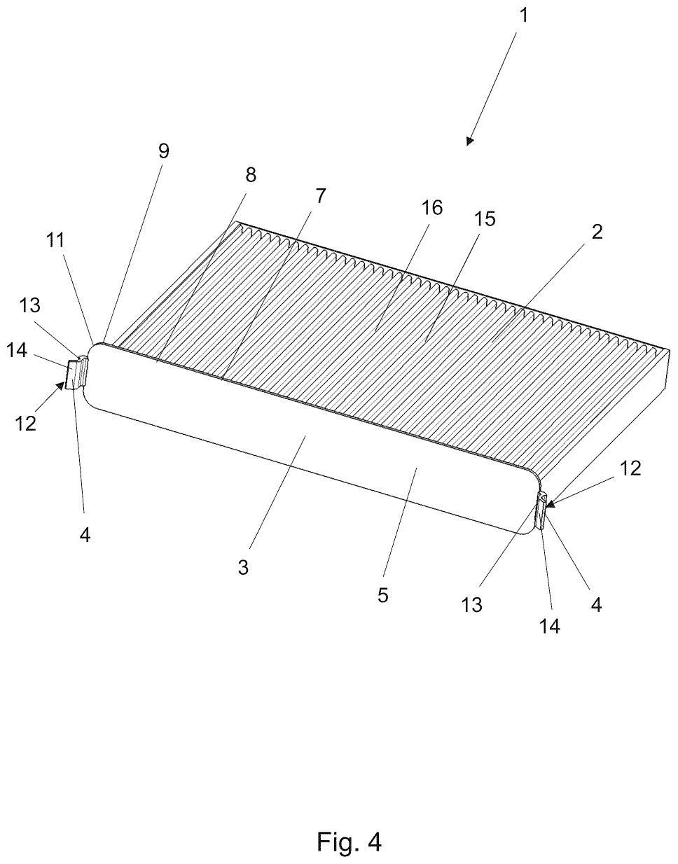

FIGS. 1 to 3 show a first embodiment of a filter 1 according to the present disclosure. FIG. 4 shows a second embodiment of a filter 1 according to the present disclosure. First, the common features of both filters 1 are described together.

The filter 1 is configured as a cabin air filter for mobile applications, in particular for applications for filtering the cabin air of motor vehicles.

The filter 1 shown in the figures comprises a pleated filter medium 2, an edge strip 3 and two retaining elements 4. The two retaining elements 4 are each arranged opposite each other on the edge strip 3 on the two narrow sides 11 of the edge strip 3. The edge strip 3 is attached to one side of the filter medium 2. The retaining element 4 is assigned to the edge strip 3. The edge strip 3 and the retaining element 4 form a locking structure 5 for fixing the filter 1 in a filter housing.

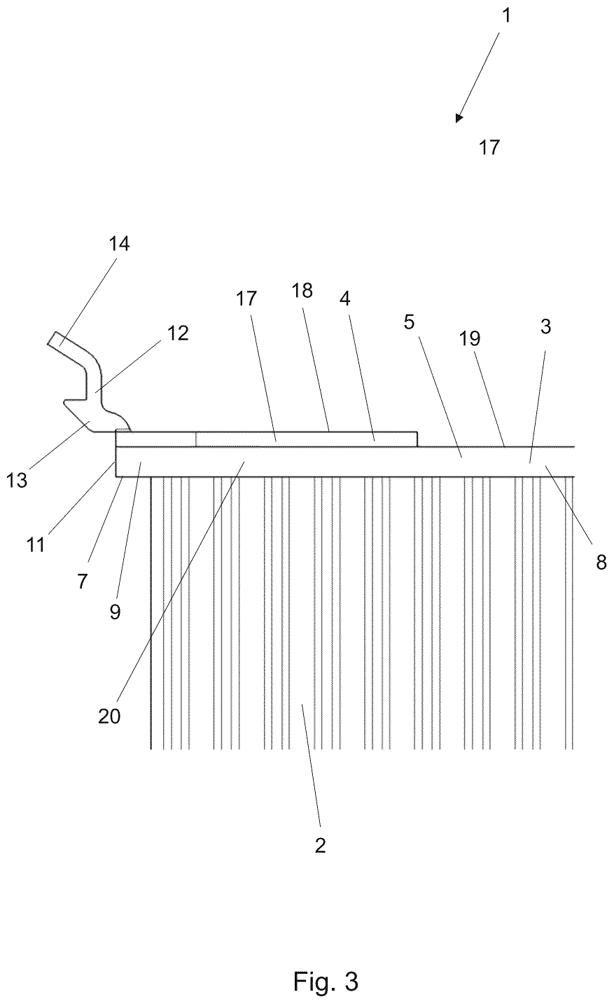

The retaining elements 4 each have a retaining structure 12, whereby the retaining structure 12 comprises a latching lug 13 and a grip section 14. The retaining structure 12 can be seen particularly clearly in FIG. 3. The latching lug 13 is configured as a latching flap, so that each of the retaining elements 4 can be form-fittingly fixed in the filter housing by means of the latching flap. In this context, it is also provided that the latching lug 13 is configured as a snap lock or retainer tab. This allows the filter 1 to be detachably connected to the filter housing. Due to the grip section 14, the connection between filter 1 and the filter housing can be established and released manually and without tools.

The filter medium 2 is zigzag-shaped and has elongated pleat walls 15 and pleat backs 16, so that the filter surface of the filter medium 2 is enlarged to improve the filtering result. The filter medium 2 is arranged on the edge strip 3 in such a way that the pleat walls 15 and the pleat backs 16 protrude essentially orthogonally from the edge strip 3.

The filter 1 comprises a seal 7 for sealing the filter 1 and filter housing, whereby the seal 7 is formed by the edge strip 3. For this purpose, the edge strip 3 has a free end 9 on each of its long sides 8 and narrow sides 11, which protrudes over the filter medium 2 and forms the seal 7. The free end 9 can be seen in particular in FIG. 1. The free end 9 can fill the gap between the filter medium 2 and the filter housing in such a way that the tightness is improved. The free end 9 has an elastic configuration.

FIGS. 1 to 3 show a first embodiment of a filter 1 according to the present disclosure, in which the retaining element 4 is made of injection-moldable plastic and the edge strip 3 is made of non-woven fabric. The retaining element 4 is connected to the edge strip 3. Thereby the retaining element 4 is configured as a molded part made of thermoplastic. Retaining element 4 and edge strip 3 are materially bonded together. The connection is preferably created by ultrasonic welding or gluing.

The retaining element 4 has a plate-shaped base body 17 with two main sides, wherein the retaining structure 12 is assigned to the first main side 18 facing away from the edge strip 3. The retaining element 4 is arranged on the edge strip 3 with the second main side facing the edge strip 3. The base body 17 is arranged on one of the narrow sides 11 of the edge strip 3. The base body 17 is arranged in a flush manner on one of the narrow sides 11 of the edge strip 3. The edge strip 3 comprises an outer side 19 facing away from the filter medium 2, wherein the retaining element 4 is arranged on the outer side 19 of the edge strip 3.

The arrangement of the two retaining elements 4 is limited to the immediate end regions 20 on the two narrow sides 11 of the edge strip 3. The two retaining elements 4 each extend in the longitudinal direction of the edge strip 3 in each case over less than 10% of the length of the edge strip 3. As a result, the two retaining elements 4 are only arranged in the end regions 20 of the edge strip 3, so that no retaining element 4 is arranged in a central region 21 of the edge strip 3 between the end regions 20.

FIG. 4 shows a second embodiment of a filter 1 according to the present disclosure, in which the retaining element 4 and the edge strip 3 are formed in one piece and in material uniformity. The retaining element 4 and the edge strip 3 are made of non-woven fabric. The material of retaining element 4 and edge strip 3 has a basis weight of approximately 580 g/m². In this embodiment, the retaining structure 12 of the retaining element 4 is integrated directly in the edge strip 3.

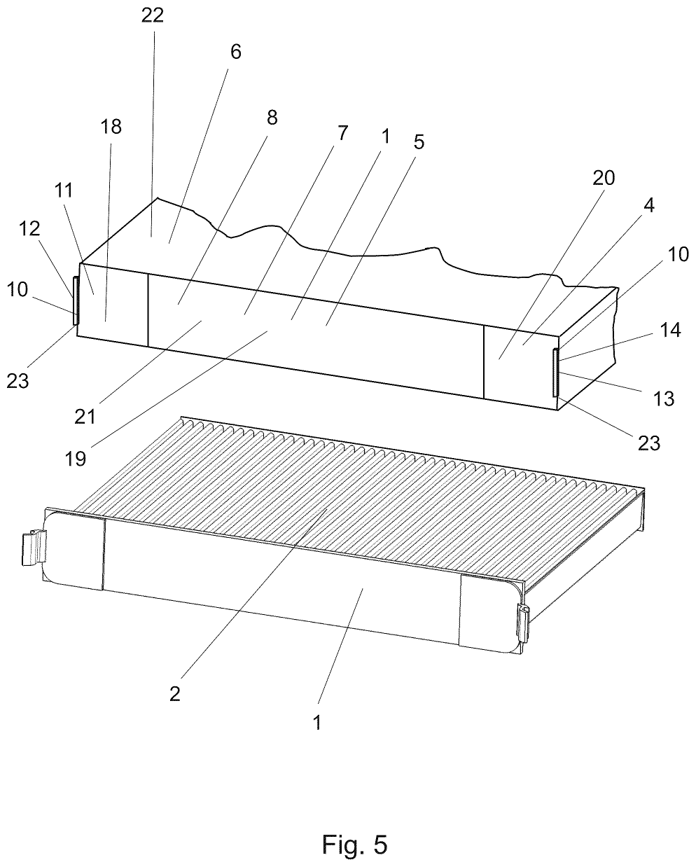

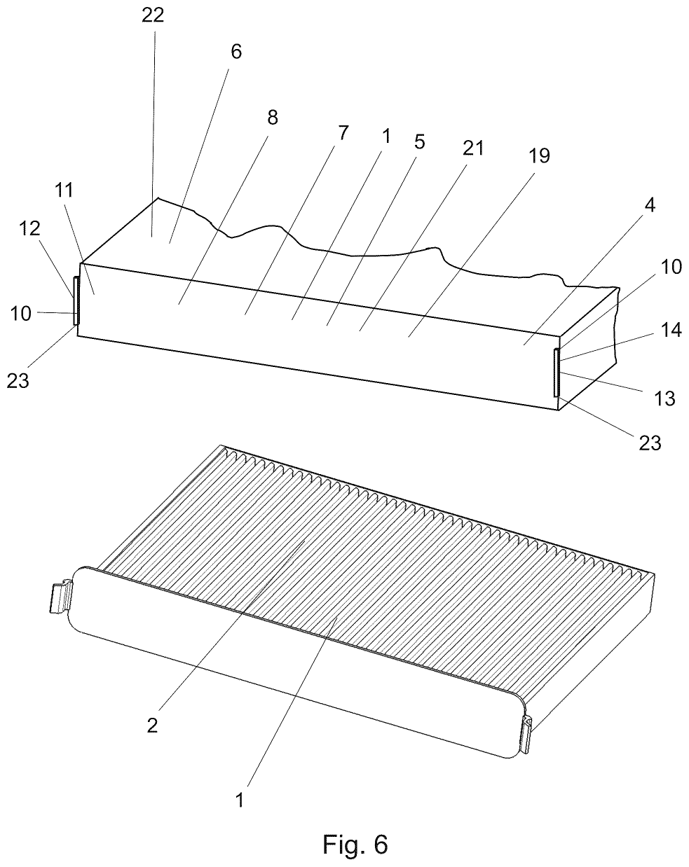

FIG. 5 shows a first embodiment of a filter arrangement 22. The filter arrangement 22 comprises a filter housing 6 and a filter 1, in this embodiment the filter 1 of FIG. 1. FIG. 6 shows a second embodiment of a filter arrangement 22. The filter arrangement 22 comprises a filter housing 6 and a filter 1, in this embodiment the filter 1 of FIG. 4. The filter housings 6 shown in FIGS. 5 and 6 are described together below. The respective filters 1 were described above in the descriptions of FIGS. 1 to 3 and 4.

The filter housing 6 has a receiving space and a receiving opening. In addition, the filter housing 6 has a further locking structure 10, which is assigned to the receiving opening and is complementary to the locking structure 5 of the filter 1, so that the receiving opening is lockable by means of the locking structure 5 of the filter 1.

The locking structure 10 of the filter housing 6 comprises two further retaining elements 23, so that the retaining elements 4 of the filter 1 are fixed to the retaining elements 23 of the filter housing 6, in order to connect the filter 1 to the filter housing 6. The retaining elements 23 of the filter housing 6 have a complementary shape to the retaining elements 4 of the filter 1, so that the retaining elements 4, 23 can be form-fittingly connected.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A filter, comprising:
a pleated filter medium;
an edge strip; and
at least one retaining element,
wherein the edge strip is fastened on one side of the filter medium,
wherein the retaining element is assigned to the edge strip, and
wherein the edge strip and the retaining element form a locking structure for fixing the filter in a filter housing.

2. The filter according to claim 1, wherein the retaining element has a retaining structure, and wherein the retaining structure comprises a latching lug and a grip section.

3. The filter according to claim 2, wherein the latching lug is configured as a latching flap such that the retaining element can be form-fittingly fixed in the filter housing by the latching flap.

4. The filter according to claim 2, wherein the connection between the filter and the filter housing is established without tools.

5. The filter according to claim 1, wherein the filter comprises a seal for sealing the filter and the filter housing, wherein the seal is formed by the edge strip.

6. The filter according to claim 5, wherein the edge strip has a free end protruding over the filter medium on at least each of its longitudinal sides, and wherein the free end forms the seal.

7. The filter according to claim 1, wherein the retaining element and/or the edge strip are configured of non-woven fabric.

8. The filter according to claim 7, wherein a material of the retaining element has a basis weight of more than 400 g/m².

9. The filter according to claim 7, wherein the material of the edge strip has a basis weight of more than 140 g/m².

10. The filter according to claim 1, wherein the retaining element and the edge strip are configured in one piece and in material uniformity.

11. The filter according to claim 1, wherein the retaining element is configured of injection-moldable plastic and the edge strip is configured of nonwoven fabric, and wherein the retaining element is connected with the edge strip.

12. The filter according to claim 1, wherein the filter has two retaining elements.

13. The filter according to claim 1, wherein the filter is configured as a mobile cabin filter.

14. The filter arrangement, comprising the filter housing and the filter according to claim 1, wherein the filter housing has a receiving space and a receiving opening, and wherein the filter housing has a further locking structure which is assigned to the receiving opening and is configured to be complementary to the locking structure of the filter, so that the receiving opening is configured to be locked by the locking structure of the filter.
